(19) United States
(12) Patent Application Publication
(10) Pub. No.: US 2017/0242648 A1
(43) Pub. Date: Aug. 24, 2017

(54) Combined Function Control And Display And System For Displaying And Controlling Multiple Functions

(71) Applicant: Geoffrey Stephen Engel, West Chester, PA (US)

(72) Inventor: Geoffrey Stephen Engel, West Chester, PA (US)

(73) Assignee: RAPC Systems, Inc., West Chester, PA (US)

(21) Appl. No.: 15/432,750

(22) Filed: Feb. 14, 2017

Related U.S. Application Data
(60) Provisional application No. 62/297,618, filed on Feb. 19, 2016.

(51) Int. Cl. G06F 3/14

(52) U.S. Cl. CPC G06F 3/1454; G06F 3/1423; G06F 2203/04803; G06F 3/0488

(57) ABSTRACT

A system which allows information from various source devices to be simultaneously displayed on a total display. The source devices may be connected to central processing unit, wired or wirelessly, which processes the images to be displayed on the total display. The total display can allow the user to select information from multiple source devices and display all of the functions simultaneously, or it can allow for the user to select a single source device and display only that information, putting all the other source devices in the background. The information displayed on the total display may also be displayed in different sized zones. The total display screen may comprise one or more screens associated with a computer or device for displaying information from one or more source devices. The total display may also be used to control the source devices.

### CROSS REFERENCE TO RELATED APPLICATIONS

This application is a non-provisional application of, and claims priority to, provisional application U.S. Application 62/297,618 filed on Feb. 19, 2016. The above referenced prior application is hereby incorporated herein by reference.

### BACKGROUND OF THE INVENTION

The present invention meets the long felt need for a single “total display” and control system that can display information from several sources and allow for control of any devices that are the source of the information being displayed. This invention is particularly useful in the marine environment.

Prior to the present invention, a marine vessel had many displays, Among the displays are a depth finder, fish finder, radar, weather channel, cameras, television display and others. In addition, there are digital displays associated with steering the vessel, controlling its direction and speed, monitoring engine performance, etc. Each of these displays was previously contained on its own separate screen or device.

The present invention combines these disparate displays on one “total display” which comprises one or more screens, and allows for control of each and every one of the devices through which information is being displayed, thus freeing up space and allowing for a more efficient control and monitoring of the vessel.

### BRIEF DESCRIPTION OF THE DRAWINGS

FIG. 1 shows a flowchart of a system for processing and displaying information from source devices onto a total display of a computer and other devices according to the invention.

FIG. 2 shows a reference photograph of a display of information from multiple source, devices on a total display according to the invention.

### DETAILED DESCRIPTION OF THE INVENTION

The subject invention provides for a system which allows information from various, source devices to be simultaneously displayed on a total display. For example, in the marine industry, many devices may be utilized to assist in performing the functions necessary for navigation or accomplishing an intended purpose. A source device may provide a means for measuring speed. Another source device may function to determine the depth of water. Still another device may function to provide sonar to determine whether fish are present near the boat. In the prior art, the information from each of these source devices was on separate displays or screens. However, the present invention combines these disparate displays on a total display allowing for simultaneous viewing of the information from more than one source device. The total display screen may comprise one or more screens associated with a computer or device for displaying information from a source device. In this manner, each computer or device may have its own total display from which information from each source, device may be viewed. in preferred embodiments, the present invention also allows for simultaneous control of each and every one, of the source devices.

Typical source devices can include fuel gauges, fuel flow sensors, engine monitors providing revolutions per minute, temperature, etc., GPS receivers, weather stations, AIS receivers, power monitoring, radar, sonar, television, and many other source devices that can provide a wide variety of information. In addition, some source devices allow for control of the source device, and are not limited to providing information. When the present invention is coupled with such devices, it can provide a means of simultaneously monitoring the source device provided information, as well as providing a means for simultaneously controlling the source devices.

Source devices can be connected to a central processing unit, or CPU. The CPU can be a computer, a server, or any device capable of receiving and processing information. Source devices can be connected via wire or wireless technology, as is known in the art. Wired connections can be accomplished via Ethernet technology, USB connections or any other known means of wiring. Wireless connections can be according to any wireless protocol available.

In an embodiment of a device of the present invention, all information from at least one source device, and control of the at least one source device, may be simultaneously viewed and controlled on the total display. The total display can allow the user to select information from multiple source devices and display all of the functions simultaneously on a total display, or it can allow for the user to select a single source device and display only that information, putting all the other source devices in the background. For example, the invention permits a user to see the radar screen, sonar, fish finder, and security cameras, on a total display at the same time. However, the invention contemplates alternate embodiments where a particular function display may be enlarged to fill the screen and then minimized so that all functions are again visible simultaneously on a total display.

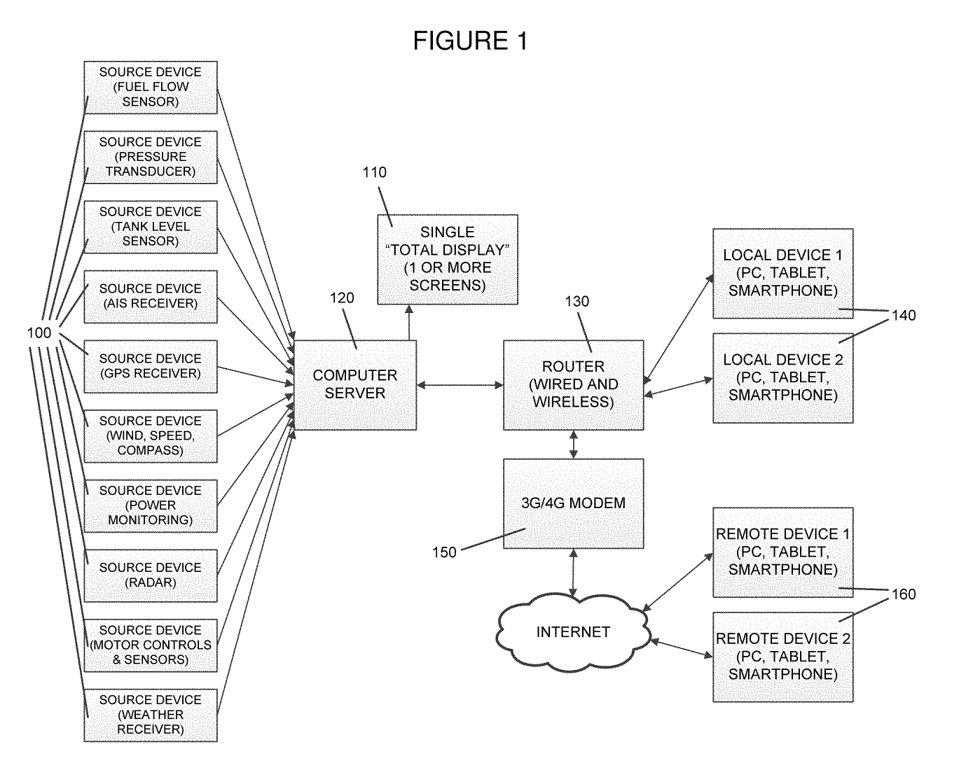

As shown in the preferred embodiment of a process of the present invention as shown in FIG. 1, a central processing unit, or computer server 120 may take information from one or more source devices 100. The source devices may comprise sonar fish finders, weather maps, speed indicators, etc. as discussed above. The computer server can then process and display the information on a total display 110 with all of the information and functions of each of the source devices displayed simultaneously in positions adjacent to those of the other functions.

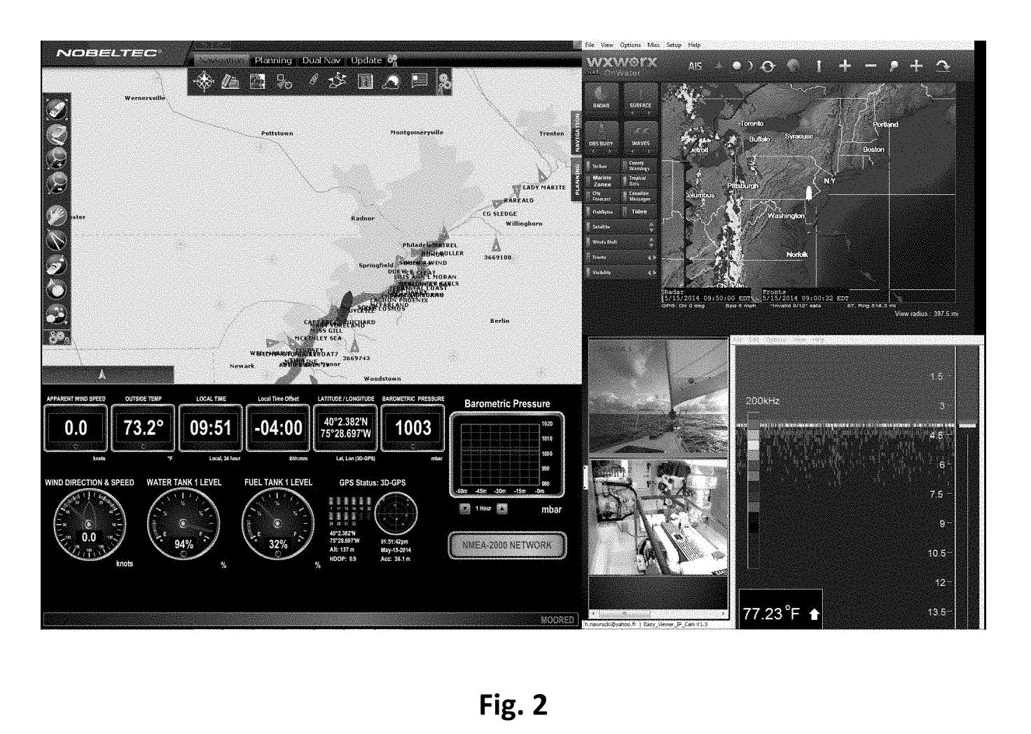

In other preferred embodiments located on marine vessel, the computer server may deliver the information to a router 130 which can permit local devices (PCs, tablets or smartphones) to view all of the information regarding the vessel on a total display anywhere onboard the vessel or even remotely from the vessel. The router 130 may also deliver the information to a wireless 3G or 4G Modem 150 which can connect to the Internet. This can permit remote devices 160 to simultaneously view all of the information regarding the vessel on a total display from a remote location. FIG. 2 shows a photographic representation of an embodiment of a total display of the present invention containing various representative functions from typical source devices simultaneously displayed on a total display.

There are many possible embodiments of the present invention that are within the scope of this disclosure. Most preferred embodiments of devices of the present invention comprise a computer system, or central processing unit This central processing unit, or CPU, can be a computer server 120 which can communicate with any or all of the source devices 100. Additional elements can be included, allowing for remote access and control as discussed above.

The various processes of the present invention can be executed via computer code or program. They can be written as software or encoded onto flash drives or microchips. The preferred embodiment of the present invention comprises a process, reduced to computer code and encoded onto a flash drive.

The processes of the present invention can be reduced to computer code and encoded in a wide variety of computer languages and programs. The exact computer language to be used will be dependent on the hardware used, and will be obvious to one skilled in the art. In embodiments of the present invention having wireless connectivity, and where the devices of the present invention can access the internet via satellite or other wireless means (including 3G and 4G networks). Similarly, the central processing unit of the present invention can be wirelessly connected to the source devices, and the CPU can also be wirelessly connected to the internet, allowing for simultaneous viewing of the information from the at least one source device from a remote location, and in still other preferred embodiments, allowing simultaneous control of the at least one source device.

No matter how the process steps of the present invention are reduced to executable code, the result is the same. Accordingly, one can use any combination of software and hardware to affect the process steps.

While the processes of the present invention can vary widely in their means of execution, the choice of programming language and other details will be largely dictated by the hardware choices made in the various embodiments of the device of the present invention. The devices of the present invention preferably include a system control, a “total display” and direct access to each source device's interfaces. The central processing unit, system control, or computer system as discussed above, can be software or process steps encoded onto hardware in the form of a microchip. The total display can be any video display system, whether it be one or more LCDs or monitors. Preferably, the total display will be touch screen capable, to add functionality without requiring additional physical control means such as levers, knobs, joysticks, mouse, trackball etc.

The invention provides for a system control to allow the user to select a function from multiple source devices and display all of the functions simultaneously on a total display. For example, the invention permits a user to see the radar screen, sonar, fish finder, and television, for example, on a total display at the same time.

In an alternate embodiment, the system control may allow, in preferred embodiments, the user to select a function from all the functions displayed, and to then display only that function. For example, if the user wants to see only the radar screen results on the total display, they can select radar and only that will be shown on the screen. All the other functions can be in the background and the radar will then occupy the whole screen. Thereafter, the user can de-select the radar function and return to the default total display screen, which will show all the functions simultaneously.

Regarding the direct access between the system controls, the total display, and the source devices, it is possible to connect via wire or wireless means. Various wired connections can include USB hardware interfaces, serial port interfaces, Ethernet networks, and NMEA-2000 (marine electronics) networks. The direct connection ensures that all software applications can be executed on the system that controls the “total display”.

It is preferred that in all embodiments of the present invention, all applications and all source devices can be executable on a single computer system, accessible through the “total display” which, in effect, simultaneously combines the displays from each source device and can allow control of each source device.

In other preferred embodiments, these source, devices, through the combined control and display, can be shared to other devices (tablets, smart-phones, computers etc). Consequently, a user can remotely view and control multiple source devices on a total display on a remote device.

In preferred embodiments of the present invention, the configuration of the total display can be performed by completing the following steps for each of the source devices to be included on the display. This system can display the user interfaces for all software applications on a “total display”.

1. Using screen divider software, divide up the “total display” screen into separate zones, which are adjacent and non-intersecting areas of the “total display”. In some cases, the size of some zones in the “total display” may be controlled by the software application which may require a specific resolution (height and width) or aspect ratio (height to width ratio).

2. For each source device, define the zone of the “total display” in which the user interface is to be displayed.

3. For each source device, remove the banner bar, if one exists, (normally seen in separate applications' user interfaces). That is, hide the application title, and the “minimize”, “maximize” and “close” buttons on its banner bar. This removal serves to ensure that the user cannot inadvertently close any applications during normal operation, and to give the appearance of a single seamless display with information and controls from at least one source device.

4. If a source device does not have an “exit” function capability within its user interface, it may be necessary to retain the “close” button on the application's banner bar.

5. Configure each source device to start automatically upon system startup. This can be performed by configuring all display applications in a task scheduler, Note that some applications may need to have an automatic startup delayed by a short period of time (30 to 60 seconds) to allow system resources (such as networking or drivers) to be available before the application starts, This ensures that the system, will startup, seamlessly with all applications from each source device allocated to their desired and specified zones.

It is preferred that the computer system that controls the “total display” have direct access to all of the hardware interfaces. This can include all USB hardware interfaces, all serial port interfaces, all Ethernet networks, and all NMEA-2000 (marine electronics) networks. This can ensure that all software applications can be executed on the computer system that can control the “total display”.

In another embodiment of the present invention, all controls or applications from each source device may be executed on a single computer system, so that the “total display” combines the displays from each source device can be shared to other devices (tablets, smart-phones, computers etc).

Specifically, the “total display” marine system of the present invention can be shared with the following configuration:

1. Configure screen sharing software such as “ZINC” or “remote host” on the single computer system which can control the marine system's “total display”. This single marine systems computer can be the defined as the “Server” or the CPU.

2. Security of the display screen data to be shared can be improved by the configuration of “secure connection path” or “secure shell” (SSH) or Virtual Private Network (VPN) on the computer system “Server” controlling the single marine systems' “total display”,

3. Configure the screen sharing software and the “secure connection path” software using usernames and passwords.

4. Connect the computer system “Server” controlling the single marine systems “total display” to a wireless and/or 3G/4G network hub. This can provide an intranet and/or internet access point for remote connections.

5. A remote device (tablet, smart-phone, computer etc) can be referred to as the “Client”.

6. Connect the remote device to the same intranet and/or internet network hub to which the “Server” is connected, by configuring the “Client” version of the screen sharing software (same as used on the “Server”). Use the usernames and passwords previously configured for screen sharing software on the “Server”.

7. If “secure connection path” software has been used on the “Server”, configure the “client” version of the “secure connection path” software (same as used on the “Server”) on the remote device. Use the usernames and passwords previously configured for “secure connection path” software on the “Server”.

8. The remote device can be configured for either remote “viewing only” or for “full remote control”.

9. The configuration of “viewing only” provides visibility of all the applications running on the “Server”, but does not permit any control. This can be used for display purposes.

10. The configuration of “full remote control” allows the remote device to perform all the same functions on the total display as can be performed by the “Server” computer total display. This allows the remote user to see and control all applications exactly as would be performed when in front of the Server's “total display”.

The various embodiments of the present invention have been disclosed in terms of preferred embodiments which fulfil all of the objects of the present invention and overcome the limitations of the prior art. Various changes, modifications, and alterations from the teachings of the present inventions may be contemplated by those skilled in the art without departing from the intended spirit and scope thereof. It is intended that the present invention only be limited by the terms of the appended claims.

I claim:

1. A process for displaying information from at least one source device and controlling the at least one source device, the process comprising:
Programming a computer system to receive information from at least one source device;
Configuring screen sharing software to display information from the at least one source device;
Configuring a connection path to connect the at least one source device with the computer system;
Connecting the computer system to a total display;
Connecting the at least one source device to the computer system; and
Displaying information from the at least one source device on a total display.

2. A process for displaying information from at least one source device and controlling the at least one source device as in claim 1, further comprising the steps of:
Providing a connection path to connect the computer system to at least one device selected, from the group consisting, of at least one local device and at least one remote device;
Connecting the computer system to the at least one device selected from the, group consisting of at least one local device and at least one remote device; and
Displaying information from the at least one source device on a total display of the at least one device selected from the group consisting of at least one local device and at least one remote device.

3. A process for displaying information from at least one source device and controlling the at least one source device as in claim 1, further comprising the steps of:
Configuring control software to allow the at least one source device to be controlled by the computer system.
Controlling the at least one source device by inputting control information into the computer system.

4. A process for displaying information from at least one source device and controlling the at least, one source device as in claim 2, further comprising the steps of:
Configuring control software to allow the at least one source device to be controlled by at least one device selected from the group consisting of at least one local device and at least one remote device.
Controlling the at least one source device by inputting control information into the at least one device selected from the group consisting of at least one local device and at least one remote device.

5. A system for displaying information from at least one source device and controlling the at least one source device, comprising:
At least one source device;
A total display; and
A computer system connected to the at least one source device and the total display, the computer system configured to receive information from the at least one source device, and to display information received from the at least one source device on the total display.

6. A system for displaying information from at least one source device and controlling the at least one source device as in claim 5, further comprising:
At least one device, selected from group consisting of at least one local device and at least one remote device, connected to the computer system, the computer system configured to receive information from the at least one source device and to display information received from the at least one source device on a total display of the at least one device.

7. A system for displaying information from at least one source device and controlling the at least one source device as in claim 5 wherein the computer system is, configured to control the at least one source device.

8. A system for displaying information from at least one source device and controlling the at least one source device as in claim 6 wherein the at least one device, selected from group consisting of at least one local device and at least one remote device, is configured to control the at least one source device.
